(19) United States
(12) Patent Application Publication
(10) Pub. No.: US 2010/0067869 A1
(43) Pub. Date: Mar. 18, 2010

(54) INFORMATION PROCESSING METHOD AND INFORMATION PROCESSING DEVICE

(76) Inventor: Kyoya Tsutsui, Kanagawa (JP)

Correspondence Address: FROMMER LAWRENCE & HAUG, 745 FIFTH AVENUE- 10TH FL., NEW YORK, NY, 10151, US

(21) Appl. No.: 12/440,032

(22) PCT Filed: Jun. 26, 2007
(86) PCT No.: PCT/JP2007/000697

§ 371 Date: Nov. 12, 2009

(30) Foreign Application Priority Data
Sep. 6, 2006 (JP) 2006-241858

(51) Int. Cl. H04N 5/91; H04N 5/50; H04N 7/26

(52) U.S. Cl. 386/95; 348/731; 386/109; 348/E05.097; 386/E05.003

(57) ABSTRACT

A first demodulation unit of a digital broadcast reproduction system extracts signals for a plurality of channels from broadcast waves input to a radio receiver, subjects the signals to analog-to-digital conversion, and temporarily stores the data in a multichannel buffer. A second demodulation unit reads, from the multichannel buffer, digital data for a selected channel corresponding to a channel selection signal input from a controller operated by a user to a channel selection acknowledging unit. The unit subjects the data thus read to the remainder of the demodulation process so as to generate a data stream. A decoding unit 48 decodes the data stream and the image data thus obtained is displayed on a display unit of a television set.

### TECHNICAL FIELD

The present invention relates to an information processing technology for decoding broadcast signals and, more particularly, to a decoding apparatus, a broadcast playback system, a broadcast playback apparatus for decoding broadcast signals for a plurality of channels contained in broadcast waves, and to an information processing method applied to the apparatuses and the system.

### BACKGROUND ART

As a result of the development of information processing technology that has taken place recently, environments in which contents such as images, music, characters, etc., are delivered have also been changed. In the field of television broadcasting, for example, terrestrial digital broadcast is now being adopted more and more widely as well as satellite digital broadcasting. This has allowed users to enjoy high-quality, functionally rich contents. In digital broadcast, content signals subjected to compression coding are delivered. Received contents are decoded and then reproduced.

### DISCLOSURE OF THE INVENTION

### Problem to be Solved by the Invention

An ordinary television set for digital broadcast is designed to extract a television signal for a channel selected by a user, from television signals corresponding to a plurality of channels and contained in broadcast waves, and decode the extracted signal so as to produce and output image data or audio data. Unlike information processing wherein a given content file obtained before the process is decoded and played back, the user receiving broadcast waves containing a plurality of channels may frequently switch channels in order to, for example, look for a desired program.

Therefore, the television set is required to respond to the channel switching operation and generate and output data for the selected channel. The time lag created between the instruction for switching and the output of data causes stress for the user. The problem could occur not only in television reception but also in any environment where a plurality of types of continuous data that varies over time are simultaneously received so that one type of data is selected and reproduced (e.g., radio reception, audio playback, experimental data measurement, etc.)

The present invention addresses the problem and its general purpose is to provide a technology capable of switching channels smoothly in reproducing multichannel signals contained in broadcast waves.

### Means to Solve the Problem

One embodiment of the present invention relates to a decoding apparatus. The decoding apparatus comprises: a buffer operative to temporarily store digital data for a plurality of channels in units of predetermined sizes; a channel selection acknowledging unit operative to acknowledge an input signal for selection of a channel; and a decoding unit operative to read from the buffer the digital data for the channel selected by the input signal acknowledged by the channel selection acknowledging unit.

The term “digital data” refers to content data (e.g., images, audio, texts, or a combination of these) encoded and delivered using a wired or wireless network. The term may also refer to data generated by subjecting signals or radio waves containing such information to a predetermined process. The decoding apparatus is adapted to decode the content data on a real time basis.

The decoding apparatus may further comprise a decoding process controller operative to switch at least a part of the decoding process performed by the decoding unit to a simplified process until a predetermined time condition is met since the channel selection acknowledging unit acknowledges the input signal for selection of a channel.

The term “simplified process” refers to a process where the computational cost of a decoding process is less than normal (e.g., a decoding process whereby the resultant content has low spatial resolution or temporal resolution).

Another embodiment of the present invention relates to broadcast reproduction system. The broadcast reproduction system comprises a decoding apparatus operative to decode broadcast data and a reproduction apparatus operative to decode the broadcast data and output the decoded data, wherein the decoding apparatus comprises: an auxiliary receiver operative to receive broadcast waves containing signals of a plurality of channels; an auxiliary converter operative to convert the broadcast waves received by the auxiliary receiver and sequentially generate digital data for the plurality of channels; a buffer operative to temporarily store digital data for a plurality of channels generated by auxiliary converter, in units of predetermined sizes; a channel selection acknowledging unit operative to acknowledge an input signal for selection of a channel; and an auxiliary decoding unit operative to read from the buffer the digital data for the channel selected by the input signal acknowledged by the channel selection acknowledging unit and to decode the read data so as to output auxiliary output data, wherein the reproduction apparatus comprises: a main receiver operative to receive the broadcast waves; a switching unit operative to acknowledge the input signal for selection of a channel; a main converter operative to extract, from the broadcast waves, the signal of the channel selected by the input signal acknowledged by the switching unit and to subject the extracted signal to conversion, thereby generating the digital data for the selected channel; a main decoding unit operative to decode the digital data generated by the main converter and to generate main output data; and an output unit operative to output the auxiliary output data generated by the auxiliary decoding unit or the main output data generated by the main decoding unit, wherein the switching unit further controls the switching of outputs such that the auxiliary output data is obtained from the decoding apparatus and is output to the output unit until a predetermined timing condition is met since the input signal for selection of a channel is obtained.

Still another embodiment of the present invention relates to a broadcast data reproduction apparatus. The broadcast data reproduction apparatus comprises: first and second processor units each operative to extract and decode a signal for a given channel from broadcast waves containing signals of a plurality of channels, in accordance with an input signal for selection of a channel; and an output unit operative to output data decoded by the first processor unit or the second processor unit, wherein the speed of decoding process performed by the second processor unit is higher than that of the first processor unit, and the output unit outputs the data decoded by the second processor unit for a predetermined period of time since the input signal is input and outputs the data decoded by the first processor unit at other periods.

Still another embodiment of the present invention also relates to a broadcast data reproduction apparatus. The broadcast data reproduction apparatus comprises: a first input unit operative to receive radio waves containing a plurality of channels; a decoding unit operative to extract, from the radio waves received by the first input unit, and decode a signal for a channel selected by an input signal for selection of a channel and to generate main output data; a second input unit operative to obtain, from an external apparatus, auxiliary output data derived from decoding the signal for the channel selected by the input signal; and an output unit operative to output the auxiliary output data obtained by the second input unit for a predetermined period of time since the input signal is input and to output the main output data generated by the decoding unit at other periods.

Yet another embodiment of the present invention relates to an information processing method. The information processing method is for performing first and second processes on a data stream being received and sequentially outputting the processed stream, and comprises: receiving a plurality of data streams; performing the first process on the plurality of data streams so as to generate a plurality of items of intermediate data sequentially; temporarily storing the plurality of items of intermediate data in a buffer in units of predetermined sizes; and in response to an input signal selecting a data stream, reading an item of intermediate data corresponding to the selected data stream from the buffer, and performing the second process on the data thus read so as to generate output data.

The term “data stream” refers to time series data, which may be data for a compression coded version of a video file, an audio file or a combination thereof. The data stream may also be uncompressed data. The term “output data” refers to data that is derived from the received data stream and that is to be output on a real time basis. Each of the first and second processes may be conversion, decoding, modification, etc.

Optional combinations of the aforementioned constituting elements, and implementations of the invention in the form of methods, apparatuses, systems, and computer programs may also be practiced as additional modes of the present invention.

### Advantage of the Invention

According to the present invention, data for a given channel is output by processing broadcast waves that contain signals for a plurality of channels in a manner that the output is responsive to channel switching.

### BRIEF DESCRIPTION OF THE DRAWINGS

FIG. 1 shows a block diagram containing modules for demodulation in an ordinary television set adapted to reproduce digital broadcast data;

FIG. 2 shows a block diagram containing modules for decoding in an ordinary television set adapted to reproduce digital broadcast data;

FIG. 3 schematically shows the mechanism for reproducing digital broadcast data according to the first embodiment;

FIG. 4 is a block diagram showing the structure of the first demodulation unit of FIG. 3;

FIG. 5 shows another exemplary mechanism for reproducing digital broadcast data according to the first embodiment;

FIG. 6 is a block diagram showing the structure of the digital broadcast reproduction system according to the first embodiment;

FIG. 7 is a time chart showing the operation of the digital broadcast reproduction system implemented by the structure shown in FIG. 6;

FIG. 8 is a block diagram showing the structure of the digital broadcast reproduction system according to the second embodiment;

FIG. 9 is a time chart showing the operation of the digital broadcast reproduction system implemented by the structure shown in FIG. 8;

FIG. 10 is a flowchart showing the sequence of processing performed in the digital broadcast reproduction system according to the second embodiment;

FIG. 11 is a flowchart showing another exemplary sequence of processing performed in the digital broadcast reproduction system according to the second embodiment; and

FIG. 12 is a block diagram showing the structure of the television set according to the third embodiment.

### DESCRIPTION OF THE REFERENCE NUMERALS

40 . . . first demodulation unit, 41 . . . first demodulation unit, 42 . . . multichannel buffer, 43 . . . multichannel buffer, 44 . . . second demodulation unit, 45 . . . second demodulation unit, 48 . . . decoding unit, 60n . . . nth band pass filter, 62n . . . nth A/D converter, 64 . . . broadband pass filter, 66 . . . A/D converter, 68 . . . digital filter, 70 . . . radio receiver, 74 . . . channel selection acknowledging unit, 78 . . . data transmitter, 80 . . . data receiver, 82 . . . display unit, 100 digital broadcast reproduction system, 102 . . . decoding apparatus, 104 . . . television set, 200 . . . digital broadcast reproduction system, 202 . . . decoding apparatus, 204 . . . television set, 240 . . . first demodulation unit, 244 . . . second demodulation unit, 248 auxiliary decoding unit, 270 auxiliary radio receiver, 282 display unit, 290 . . . operation controller, 293 main radio receiver, 295 . . . main demodulation unit, 297 . . . main decoding unit, 299 . . . switching unit, 302 . . . television set, 304 . . . channel selection acknowledging unit, 306 . . . decoding unit, 308 . . . decoding process controller

### BEST MODE FOR CARRYING OUT THE INVENTION

### First Embodiment

The first embodiment relates to a decoding technology for digital terrestrial broadcast (hereinafter, simply referred to as digital broadcast). A description of an ordinary decoding process for digital broadcast will be given to illustrate the features of the embodiment. The processing sequence and processing details described herein are only illustrative and are not intended to limit the scope of the embodiment.

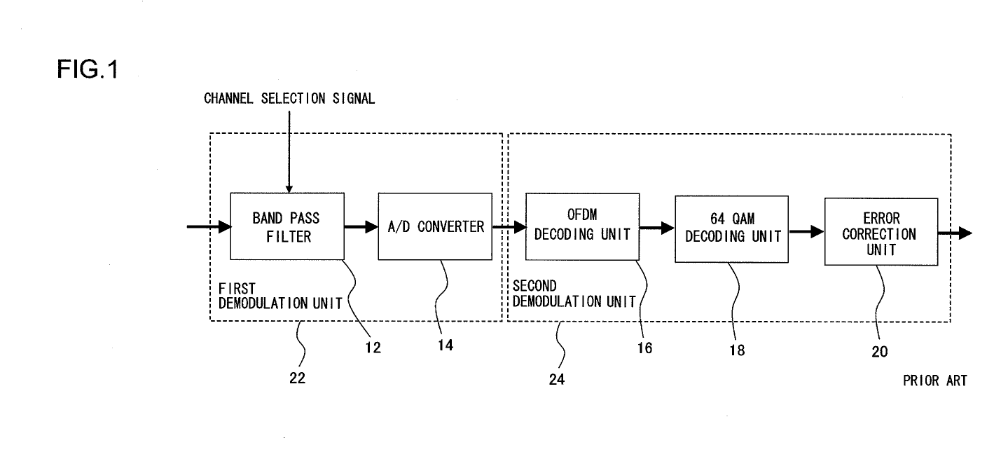

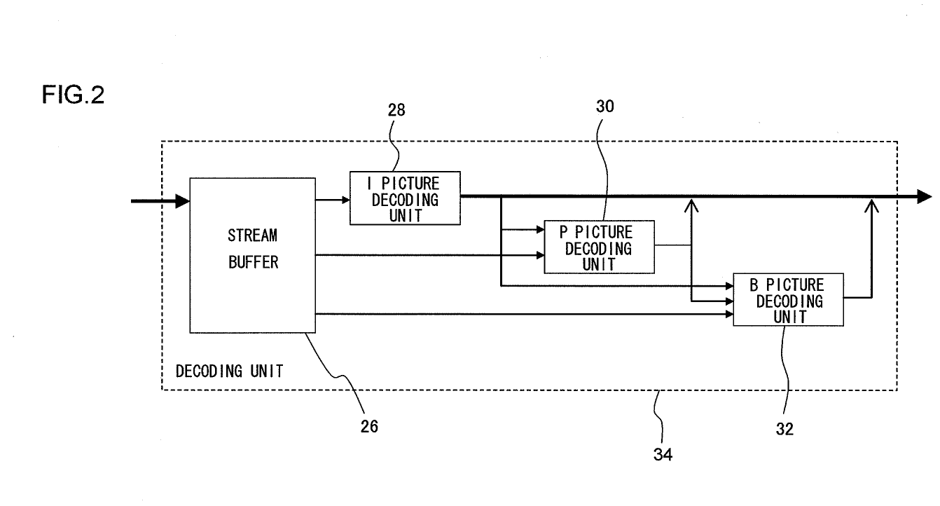

FIGS. 1 and 2 show the structure of an ordinary television set for reproducing digital broadcast data. For ease of understanding, the process related to image data contained in digital broadcast signals will only be described hereinafter. It should be noted, however, that similar processes may be applied to audio data, text data, etc.

In digital broadcasting, digital data for a plurality of channels is subject to orthogonal frequency division multiplexing (OFDM), compression-coding according to MPEG-2, and 64 quadrature amplitude modulation (QAM) before being delivered. For reproduction, broadcast waves containing frequency bands corresponding to respective channels are subject to demodulation processes. The demodulated data is subject to decoding processes. FIG. 1 shows modules for demodulation and FIG. 2 shows modules for decoding.

Referring to FIG. 1, broadcast waves are demodulated by a first demodulation unit 22, which includes a band pass filter 12 and an A/D converter 14, and a second demodulation unit 24, which includes an OFDM decoding unit 16, a 64 QAM decoding unit 18, and an error correction unit 20. Broadcast waves are first input to the band pass filter 12. A channel selection signal supplied by a user via a remote controller, etc. is input to the band pass filter 12. This causes the band pass filter 12 to extract a signal in the frequency band corresponding to the channel designated by the channel selection signal and to output the extracted signal to the A/D converter 14.

The digital data produced by analog-to-digital conversion in the A/D converter 14 is subject to OFDM decoding and QAM decoding by the OFDM decoding unit 16 and the 64 QAM decoding unit 18, respectively. The data is then subject to error correction in the error correction unit 20.

The digital data processed by the first demodulation unit 22 and the second demodulation unit 24 and output accordingly is input to a decoding unit 34 shown in FIG. 2 and is temporarily stored as a data stream in a stream buffer 26. Included in a data stream of MPEG-2 are intra-coded pictures (I pictures), which are intra-frame coded pictures, predicted pictures (P pictures), which are coded by forward inter-frame prediction with reference to past frames, and bi-directional predicted pictures (B pictures), which are coded by bidirectional niter-frame prediction with reference to past and future frames. These pictures are sequentially decoded by the I-picture decoding unit 28, the P-picture decoding unit 30, and the B-picture decoding unit 32 so as to obtain image data to be ultimately displayed.

Each time the user provides a channel selection signal in an ordinary television set such as this, the frequency band of the selected channel is extracted from the broadcast waves received for demodulation and decoding. For this reason, a time lag is created between the input of the channel selection signal and the display of the image of the channel. In particular, in a compression-coding technique, such as MPEG-2, using interframe prediction, a plurality of correlated items of frame data need be processed in order to generate image frames to be ultimately displayed. Thus, the time lag may exceed the duration that can be tolerated.

This embodiment addresses this problem by reducing the time lag between the switching of channels and the display of the image so as to reduce stress on the user, while also suppressing the cost by taking full advantage of the structure of an ordinary television set.

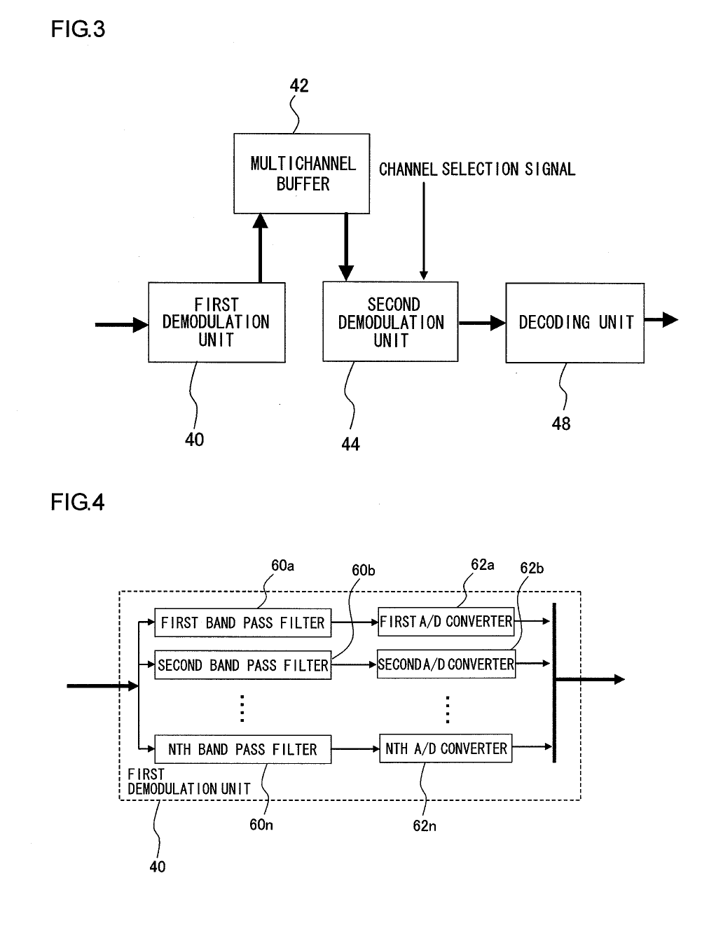

The method for reproducing digital broadcast data according to this embodiment will be described, with reference to the structure of an ordinary television set. FIG. 3 schematically shows the mechanism for reproducing digital broadcast data according to this embodiment. The mechanism for reproduction according to this embodiment includes a first demodulation unit 40, a multichannel buffer 42, a second demodulation unit 44, and a decoding unit 48. The first demodulation unit 40, the second demodulation unit 44, and the decoding unit 48 generally correspond, in their functions, to the first demodulation unit 22, the second demodulation unit 24, and the decoding unit 34 of the ordinary television set shown in FIGS. 1 and 2.

In other words, the broadcast wave is converted into digital data by the first demodulation unit 40. A data stream is generated by the second demodulation unit 44. The decoding unit 48 generates image data to be displayed.

In this embodiment, a channel selection signal is input to the second demodulation unit 44. Therefore, irrespective of the channel selection signal, the first demodulation unit 40 processes radio waves corresponding to a plurality of channels (e.g., all channels included in the broadcast waves received). Accordingly, the first demodulation unit 40 outputs digital data for a plurality of channels. The multichannel buffer 42 temporarily stores the digital data for the plurality of cannels output by the first demodulation unit 40, the size of data stored being predefined.

The second demodulation unit 44 reads only the digital data corresponding to the channel designated by the channel selection signal from the multichannel buffer 42. Like the second demodulation unit 24 of FIG. 1, the unit 44 then subjects the digital data to OFDM decoding, 64 QAM decoding, and error correction. Like the decoding unit 34 of FIG. 2, the decoding unit 48 temporarily stores the digital data output by the second demodulation unit 44 as a data stream and decodes the data according to MPEG-2. In this way, the image data for the channel corresponding to the channel selection signal is obtained.

The description given above and below assumes digital broadcasting. Therefore the digital data read by the second demodulation unit 44 is described as being subject to OFDM decoding, 64 QAM decoding, and error correction. It is also assumed that the decoding process performed by the decoding unit 48 is in accordance with MPEG-2. The assumption shall not be interpreted to limit the scope of the invention. More specifically, the only requirement is that the demodulation generates a data stream subject to decoding and the decoding generates image data to be displayed. Specific schemes for demodulation or decoding may be determined as appropriate depending on the signal received.

FIG. 4 shows an exemplary structure of the first demodulation unit 40. The first demodulation unit 40 comprises a total of n band pass filters including a first band pass filter 60a, a second band pass filter 60b, . . . , and an n-th band pass filter 60n and also comprises a total of n A/D converters including a first A/D converter 62a, a second A/D converter 62b, . . . , and an nth A/D converter 62n, which are connected to the respective band pass filters, where n denotes the total number of channels included in the broadcast waves received or the number of channels preset by the user.

The frequency bands occupied by the respective channels are set in the first band pass filer 60a, the second band pass filter 60b, . . . , and the nth band pass filter 60n so that the signals corresponding to the respective channels are extracted from the broadcast waves received. The first A/D converter 62a, the second A/D converter 62b, . . . , and the nth A/D converter 62n subject the signals output from the respective band pass filters to analog-to-digital conversion.

The multichannel buffer 42 temporarily stores the n items of digital data output by the first demodulation unit 40 for the respective channels. For example, digital data of a predefined size on the order of one to several groups of pictures (GOPs) is stored. The size of the data stored is preset to an optimum value determined through experiments, etc., in consideration of the speed of demodulation and decoding in the subsequent stages, the permitted capacity of the memory used in the multichannel buffer 42, etc.

According to the mechanism for reproducing digital broadcast data of this embodiment shown in FIGS. 3 and 4, digital data for a plurality of channels is stored regardless of the channel selection signal. When the channel is switched by the channel selection signal, ultimate image data is obtained only by subjecting the digital data corresponding to the selected channel to the demodulation and decoding processes that remain to be performed. In other words, fewer steps are required between the input of the channel selection signal and the output of image data. As a result, the time lag between the switching of channels and the display of the image of the channel is reduced.

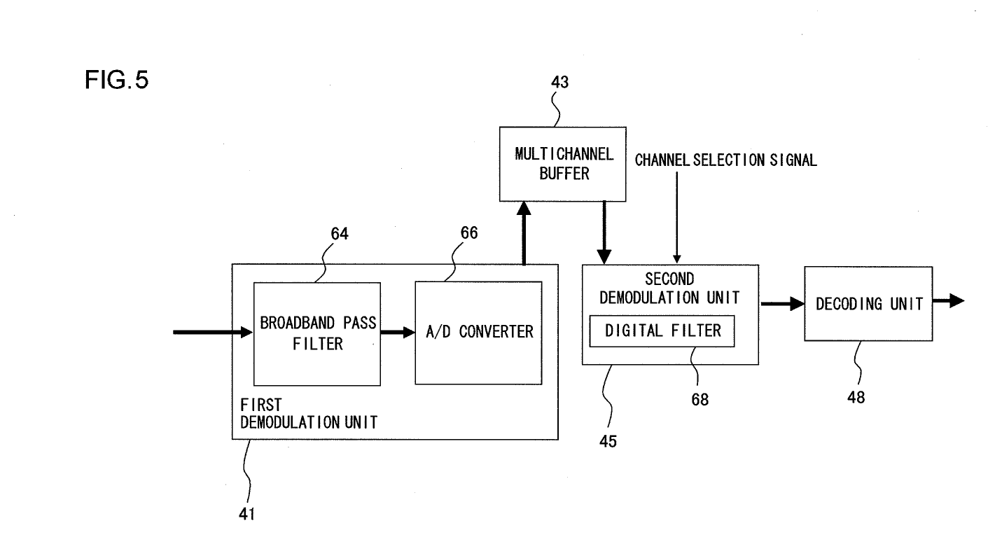

A first demodulation unit 41 of FIG. 5 includes a single broad band pass filter 64 and a single A/D converter 66. A second demodulation unit 45 includes a digital filter 68. Although OFDM decoding, 64 QAM decoding, and error correction illustrated in FIG. 1 are also performed in the second demodulation unit 45, the processes are omitted from the illustration.

The first demodulation unit 40 shown in FIG. 4 extracts signals for respective channels using the n band pass filters before analog-to-digital conversion. In the example illustrated in FIG. 5, separation of signals for respective channels is not performed. Undesired frequencies are only eliminated by the broad band pass filter 64. A broadband signal including signals corresponding to a plurality of channels is input to the A/D converter 66.

The broadband signal including data for a plurality of channels is subject to analog-to-digital conversion by the A/D converter 66 and temporarily stored in a multichannel buffer 43. Meanwhile, the channel corresponding to the channel selection signal input to the second demodulation unit 45 is set in the digital filter 68. The second demodulation unit 45 reads the digital data including data for a plurality of channels from the multichannel buffer 43. The digital filter 68 extracts only the digital data for the selected channel.

The subsequent processes are performed on the digital data for a single channel. Therefore, demodulation and decoding as described with reference to FIG. 1 or FIG. 3 may be performed by the second demodulation unit 45 and the decoding unit 48. The structure described above can also provide the same advantage as the structure of FIGS. 3 and 4 since the processing time elapsed since the input of the channel selection signal is reduced by temporarily storing digital data for a plurality of channels.

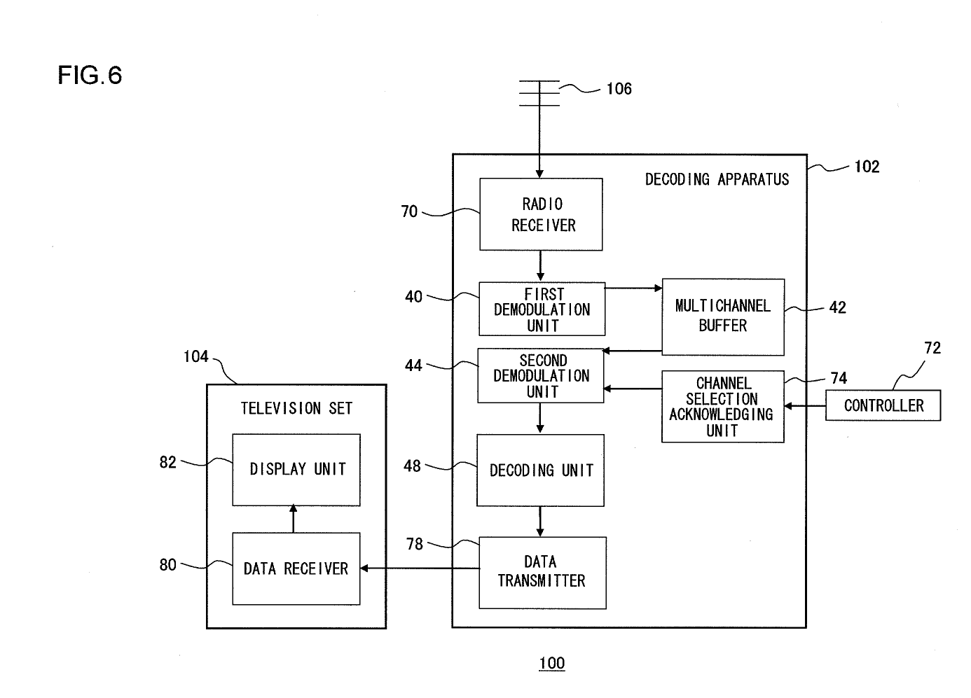

A description will now be given of an exemplary structure of the apparatus to which the mechanism for reproducing digital broadcast data described above is applied. FIG. 6 shows the structure of a digital broadcast reproduction system according to this embodiment. The elements depicted in FIG. 6, etc. as functional blocks for performing various processes are implemented in hardware by CPUs, memories, or other LSI's, and in software by programs etc., for implementing image processing. Therefore, it will be obvious to those skilled in the art that the functional blocks may be implemented in a variety of manners by hardware only, software only, or a combination of thereof.

The digital broadcast reproduction system 100 includes a decoding apparatus 102 and a television set 104. The decoding apparatus 102 receives broadcast waves from an antenna 106 and decodes the data for the channel selected by the user using a controller 72 so as to generate image data.

The television set 104 obtains the image data generated by the decoding apparatus 102 and displays the image accordingly. Thus, the requirement for the television set 104 according to this embodiment is that it is configured for connection to the decoding apparatus 102 so as to receive and display image data. An ordinary television set provided with a video input terminal may be used. A display apparatus that does not include a tuner, etc. may also be used.

The decoding apparatus 102 includes a radio receiver 70 for receiving broadcast waves from the antenna 106, a first demodulation unit 40 for extracting signals for a plurality of channels and subjecting the extracted signals to analog-to-digital conversion, a multichannel buffer 42 for temporarily storing digital data for a plurality of channels, a channel selection acknowledging unit 74 for obtaining a channel selection signal via infrared, etc. from the controller 72 operated by the user, a second demodulation unit 44 for obtaining the digital data for the channel corresponding to the channel selection signal and subjecting the data to OFDM decoding, 64 QAM decoding, and error correction, a decoding unit 48 for decoding a demodulated data stream according to MPEG-2 and generating image data accordingly, and a data transmitter 78 for transmitting the image data to the television set 104.

Referring to FIG. 6, the first demodulation unit 40, the multibuffer 42, the second demodulation unit 44, and the decoding unit 48 may be embodied by the blocks described with reference to FIG. 3 so that the same numerals are used. Accordingly, the first demodulation unit 40 may have the structure shown in FIG. 4. Meanwhile, the first demodulation unit 40, the multibuffer 42, the second demodulation unit 44 may alternatively be embodied by the first demodulation unit 41, the multibuffer 43, the second demodulation unit 45 described with reference to FIG. 5.

The television set 104 includes a data receiver 80 for receiving the image data for the user selected channel from the decoding unit 102, and a display unit 82 for displaying the image data in sequence. The decoding unit 102 in this structure continuously receives broadcast waves while the television set 104 is outputting image data and subjects the received signals to demodulation and decoding, regardless of whether a channel selection signal is received from the controller 72. Thus, digital data of a predetermined size for a plurality of channels is temporarily stored in the multichannel buffer 42 at any given time.

Of the digital data stored in the multichannel buffer 42, the digital data for the channels other than that selected at the point of time that the first demodulation unit 40 generates new digital data is discarded in the order of storage so that the new data is added. The digital data for the selected channel is read by the second demodulation unit 44 and is demodulated and decoded by the second demodulation unit 44 and the decoding unit 48, respectively.

When a new channel selection signal is acknowledged by the channel selection signal 74, the second demodulation unit 44 changes the target of reading and starts reading the digital data for the newly selected channel from the multichannel buffer 42. By using such a structure, the image data for the channel selected by the controller 72 is transmitted to the television set 104.

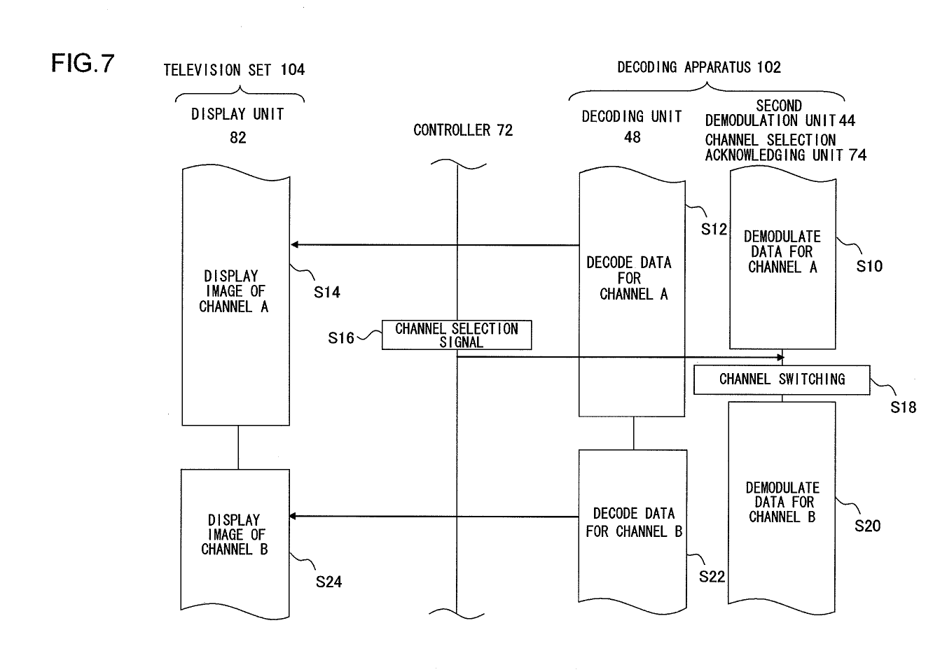

FIG. 7 is a time chart showing the operation of the digital broadcast reproduction system implemented by the structure described above. The figure shows that time elapses from top to bottom. The intervals as illustrated are enlarged or reduced as appropriate for ease of understanding and do not reflect the actual time.

It will be assumed that the image of channel A is being selected and displayed at start time (i.e., the point of time illustrated at the top of the figure). Channel A is set in a register (not shown) of the second demodulation unit 44 of the decoding apparatus 102. The second demodulation unit 44 is sequentially reading the digital data for channel A from the multichannel buffer 42 and demodulating the data (S10). The demodulated data is decoded by the decoding unit 48 (S12) and is transmitted to the television set 104 as image data. The television set 104 displays the image data for channel A thus transmitted on the display unit 82 (S14).

When a channel selection signal for selecting channel B is input from the controller 72 to the channel selection acknowledging unit 74 (S16), the channel selection acknowledging unit 74 switches from channel A to channel B by setting the register of the second demodulation unit 74 as such (S18). In accordance with the setting, the second demodulation unit 44 reads the digital data for channel B from the multichannel buffer 42 and starts demodulating the data accordingly (S20).

Even while the channel switching process is being performed by the channel selection acknowledging unit 74, the decoding unit 48 may continue the decoding process of S12 until the data stream for channel A stored in the stream buffer 26 is completely decoded. For a very brief period of time since the input of the channel selection signal in S16, the image of channel A is displayed on the television set 104.

As the data stream for channel B generated in the demodulating process in S20 reaches the decoding unit 48, the unit 48 decodes the data stream (S22). The image data for channel B generated as a result is transmitted to the television set 104 and is displayed on the display unit 82 (S24).

Through the steps described above, the image for the selected channel is displayed on the television set 104. During the operation, the first demodulation unit 40 continues to generate digital data for a plurality of channels including channel A and channel B. As mentioned above, separation of signals for respective channels may be performed either in the first demodulation unit 40 or the second demodulation unit 44.

According to the embodiment described above, the steps from the reception of broadcast waves to the conversion into digital data are performed for a plurality of channels (e.g., all channels). The data of a predetermined size is buffered at any given time for the channels. This reduces the time elapsed between the input of a channel selection signal for switching channels and the generation of image data for the designated channel. Thereby, the time lag elapsed until the image is displayed is reduced.

Since an ordinarily used television set can be used in the system, introduction of the system is easy for the user. In an operating environment where the time lag is not a concern (e.g., when it is assured that a single channel continues to be viewed) the image can be displayed only by using the television set 104 by, for example, turning the decoding apparatus 102 off. Thus, the embodiment provides an environment that meets overall user needs by addressing, for example, power consumption considerations.

The decoding apparatus included in the system can be manufactured inexpensively and easily only by modifying the structure of the band pass filters and A/D converters of an ordinary television set and introducing a multichannel buffer.

### Second Embodiment

According to the first embodiment, image data generated by the decoding apparatus 102 is transmitted to and displayed by the television set 104 regardless of whether the channel is switched. According to the second embodiment, the television set is responsible for the primary process of generating image data and the decoding apparatus generates image data using a multichannel buffer only in the event that the channel is switched. The basic method of processing is similar to that described with reference to FIG. 3 of the first embodiment. The following description highlights the difference from the first embodiment. Those constituting elements that are similar to those used in the first embodiment are denoted by the same reference numerals and the description of the elements is omitted.

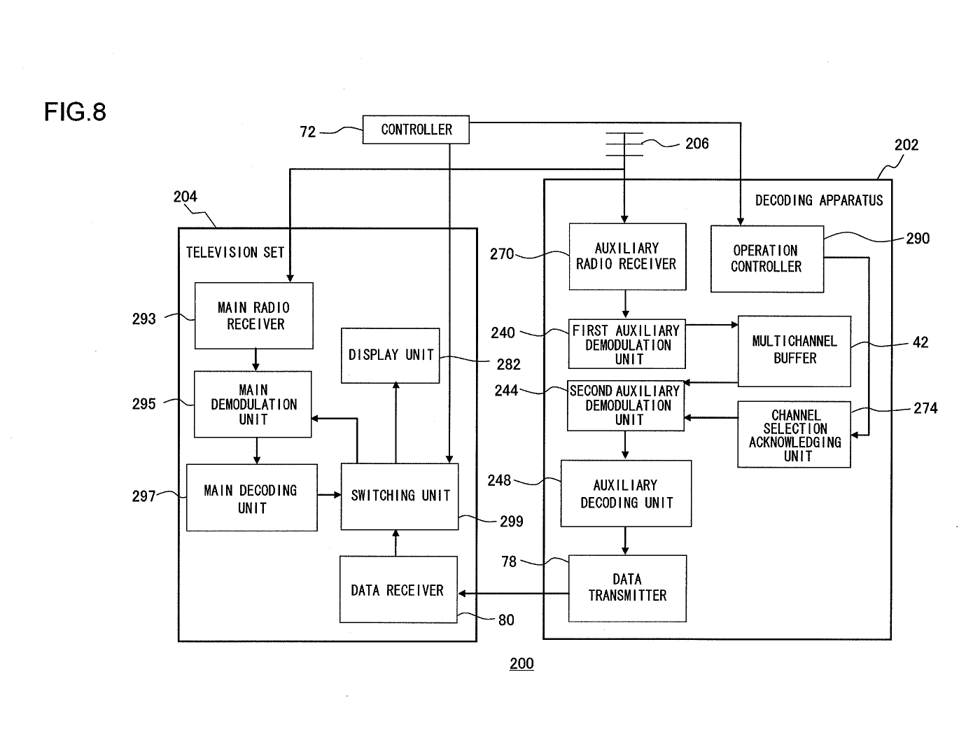

FIG. 8 shows the structure of the digital broadcast reproduction system according to the second embodiment. The digital broadcast reproduction system 200 includes a decoding apparatus 202 and a television set 204. As in the first embodiment, the television set 204 has the function of obtaining image data from the decoding apparatus 202 and displaying the image accordingly. The difference from the first embodiment is that the television set 204 operates as a main apparatus for generating image data. Like an ordinary television set, the television set 204 demodulates and decodes the signal of a channel corresponding to the channel selection signal. Another difference from the first embodiment is that the television set 204 switches the image data to be displayed between the image data generated by demodulation and decoding in the set 204 and the image data transmitted from the decoding apparatus 202.

Since the second embodiment assumes the reproduction of digital television broadcast data, the television set 204 is included in the system. Similar systems may be built using reproduction apparatuses adapted to the contents processed. For example, a radio receiver may be included in the system for reproduction of radio broadcast data.

As in the first embodiment, the decoding apparatus 202 constantly converts signals of a plurality of channels into digital data and temporarily stores the data in the multichannel buffer 42. Meanwhile, the decoding apparatus 202 differs from the apparatus 102 of the first embodiment in that it demodulates and decodes data for a channel selected by switching, only when the channel is switched.

The television set 204 includes a main radio receiver 293 for receiving broadcast waves from an antenna 206, a switching unit 299 for obtaining a channel selection signal from the controller 72 operated by a user and switching image data to be displayed, a main demodulation unit 295 for extracting the signal of the channel corresponding to the channel selection signal from the broadcast waves and subjects the signal to analog-to-digital conversion and demodulation, a main decoding unit 297 for decoding a demodulated data stream so as to generate image data, a data receiver 80 for receiving the image data from the decoding apparatus 202, and a display unit 282 for displaying the image data in accordance with the switching control performed by the switching unit 299.

The television set 204 may be configured by adding the switching unit 299 to an ordinary television set described with reference to FIGS. 1 and 2. For example, an apparatus having the function of the switching unit 299 may be externally coupled to an ordinary television set. Accordingly, the main demodulation unit 295 may comprise the first demodulation unit 22 and the second demodulation unit 24 shown in FIG. 1. The main decoding unit 297 may be configured in a similar manner as the decoding unit 34 shown in FIG. 1.

The decoding apparatus 202 includes an auxiliary radio receiver 270, a first auxiliary demodulation unit 240, a second auxiliary demodulation unit 244, and an auxiliary decoding unit 248, which function in a similar manner as the radio receiving unit 70, the first demodulation unit 40, the second demodulation unit 44, and the decoding unit 48, respectively, which are illustrated in FIG. 6 showing the first embodiment. The decoding apparatus 202 includes the multichannel buffer 42 and the data transmitter 78, which function in a similar manner as the multichannel buffer 42 and the data transmitter 78 of FIG. 6, respectively.

The decoding apparatus 202 further includes an operation controller 290 for obtaining a channel selection signal from the controller 72 and controlling the start and stop of the processes of demodulation and decoding, and a channel selection acknowledging unit 274 for obtaining the selected channel from the operation controller 290 and sets the channel subject to demodulation and decoding.

According to the second embodiment, the channel selection signal from the controller 72 is input to both the television set 204 and the decoding apparatus 202. Concurrently with the start of demodulation and decoding of the signal of the channel corresponding to the channel selection signal, the television set 204 switches to the display of the image data obtained from the decoding apparatus 202. When a predetermined number of frames have been output, or when a predetermined time has elapsed, the set 204 switches back to the image data demodulated and decoded locally.

The decoding apparatus 202 starts reading the digital data for the channel corresponding to the channel selection signal from the multichannel buffer 42 and generates image data by subjecting the data to demodulation and decoding. Demodulation and decoding are performed on data of a predetermined size (e.g., data for the duration of one to several seconds).

According to this embodiment, digital data for a plurality of channels is temporarily stored in the multichannel buffer 42 of the decoding apparatus 202. When the user switches channels, the image data generated using the data is displayed. Therefore, as in the first embodiment, the time lag between the input of the channel selection signal and the display of the image of the channel is reduced. In order to promote the effect of reducing a time lag, it is desirable to demodulate and decode the digital data for the selected channel read from the multichannel buffer 24 at a high speed.

By using a processor capable of high speed operation in the decoding apparatus 202, the time lag is further reduced. If, however, a high speed processor is operated irrespective of whether the channel is switched, as in the first embodiment, power consumption is increased as compared with the case that only an ordinary television set is operated. According to this embodiment, parts of the demodulation and decoding processes of the decoding apparatus 202 may be suspended in a period that the channel is not switched, i.e., in a period that the data stream of a given channel may continuously be decoded. As a result, increase in power consumption is mitigated while promoting the effect of reducing a time lag by introducing a high speed processor in the decoding apparatus 202.

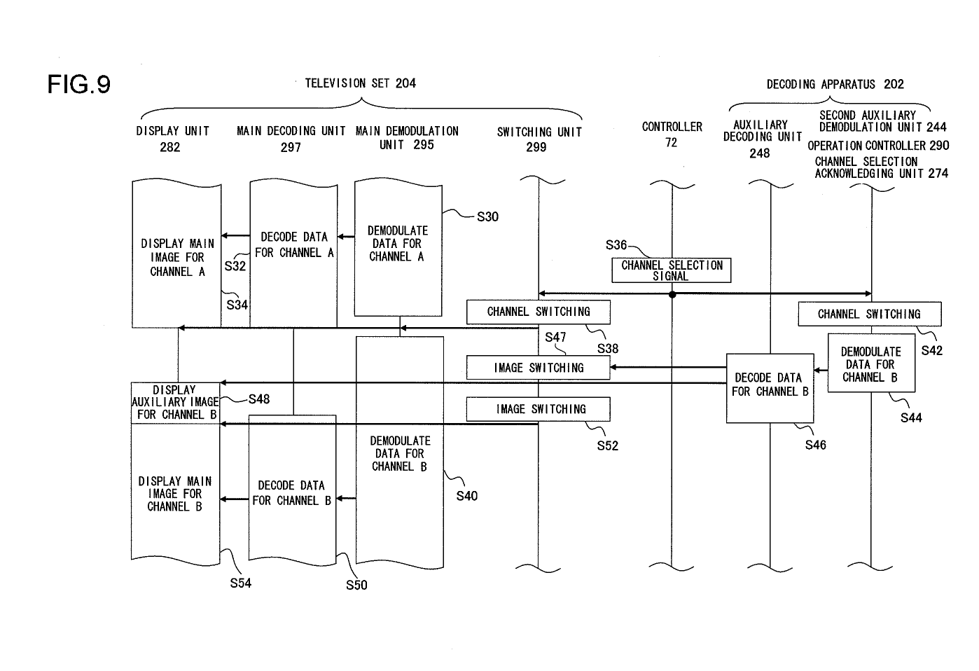

FIG. 9 is a time chart showing the operation of the digital broadcast reproduction system 200 implemented by the structure shown in FIG. 8. The notation used in FIG. 9 is the same as that of FIG. 7 illustrating the first embodiment. It will be assumed that a given channel A is being selected at start time and the image of channel A decoded by the television set 204 is being displayed on the display unit 282. In other words, the main demodulation unit 295 of the television set 204 is extracting the signal of channel A from the broadcast waves and demodulating the extracted signal (S30). The main decoding unit 297 is decoding the data stream thus demodulated (S32). The display unit 282 is displaying the image data for channel A obtained by decoding (S34). In FIG. 9 and the following description, the image obtained as a result of demodulation and decoding by the television set 204 will be referred to as a main image and the image obtained as a result of demodulation and decoding by the decoding apparatus 202 will be referred to as an auxiliary image.

In the state as described above, a channel signal that selects channel B is input from the controller 72 to the switching unit 299 of the television set 204 and the operation controller 290 of the decoding apparatus 202 (S36). The switching unit 299 of the television set 204 changes the setting of the band pass filter, etc., of the main demodulation unit 295 so as to change from channel A to channel B for extraction of the signal from the broadcast waves. The switching unit 299 also switches to the data from the decoding apparatus 202 so that the image is output to the display unit 282 accordingly (S38). In response to the switching, the main demodulation unit 295 starts extracting and demodulating the signal of channel B (S40).

Meanwhile, the operation controller 290 of the decoding apparatus 202 receives the channel selection signal and notifies the channel acknowledging unit 274 that channel B is newly selected. Concurrently, the controller 290 starts the operation of the second auxiliary demodulation unit 244 and the auxiliary decoding unit 248. The channel selection acknowledging unit 274 switches from channel A to channel B by setting the register of the second auxiliary demodulation unit 244 as such (S42). In accordance with the setting, the second auxiliary demodulation unit 244 reads the digital data for channel B from the multichannel buffer 42 so as to start demodulating the data and generating a data stream accordingly (S44). When an I picture included in the data stream arrives, the auxiliary decoding unit 248 decodes the digital data (S46).

The image data for channel B generated as a result of decoding in the decoding apparatus 202 is transmitted to the television set 204 and displayed as the auxiliary image of channel B on the display unit 282 (S48). The switching unit 299 performs switching such that, when an image for the current time is generated in the decoding apparatus 202, the display of the auxiliary image is started with the image for the current time (S47). By allowing the second auxiliary demodulation unit 244 to demodulate digital data stored in the multichannel buffer, i.e., data occurring before the current time, the auxiliary decoding unit 248, which obtains previous I pictures for channel B, is capable of generating images at an earlier point of time than otherwise. Ultimately, the television set 204 is capable of displaying the image for the current time earlier than other wise.

All this while, the main demodulation unit 295 of the television set 204 is performing a demodulation process for channel B (S40). When an I picture included in the data stream produced by the unit 295 reaches the main decoding unit 297, the main decoding unit 297 starts decoding the stream (S50). When a predetermined period of time has elapsed, or when a predetermined number of frames of auxiliary images have been displayed, the switching unit 299 of the television set 204 switches from the auxiliary image to the main image for display on the display unit 282 (S52). Elapsed time is measured by a timer (not shown) built in the switching unit 299.

The timing of switching is preset through experiments or simulation according to the interval elapsed since the input of the channel selection signal until the display of the main image is enabled, or according to the number of frames of auxiliary image required during the interval. As a result, the display unit 282 displays the main image of channel B (S54).

The decoding apparatus 202 performs demodulation and decoding processes at least until the generation of image data comprising the number of frames required before the display is switched to the main image of the television set 204 is completed. When it is ready to switch the display, the operation controller 290 halts the operation of the second auxiliary demodulation unit 244 and the auxiliary decoding unit 248. The timing of halt may be defined in units of GOPs or may be determined according to the time elapsed. Whichever method is used to determine the timing, a value calculated based on the timing of switching from the auxiliary image to the main image is preset.

Demodulation for channel B, started in S40 by the main demodulation unit 295 of the television set 204 subsequent to the channel switching process in S38, includes extraction of the signal of channel B from the broadcast waves and analog-to-digital conversion. Therefore, as shown in FIG. 9, a relatively large time difference is created between the start of the demodulation for channel B in S40 and the start of the decoding process in S50.

Meanwhile, the demodulation process for channel B by the second auxiliary demodulation unit 244 of the decoding apparatus 202, started in response to the channel switching process in S42, starts in the middle of the overall demodulation process, the time difference between the start of the demodulation process in S44 and the start of the decoding process in S46 is relatively small. As a result, by allowing the decoding apparatus 202 to provide the image of channel B occurring a little earlier than starting image of the main image of channel B and allowing the provided image to be displayed so as to fill an interval elapsed until the main image is displayed, the image of channel B is displayed at a comparatively early stage in response to the channel switching.

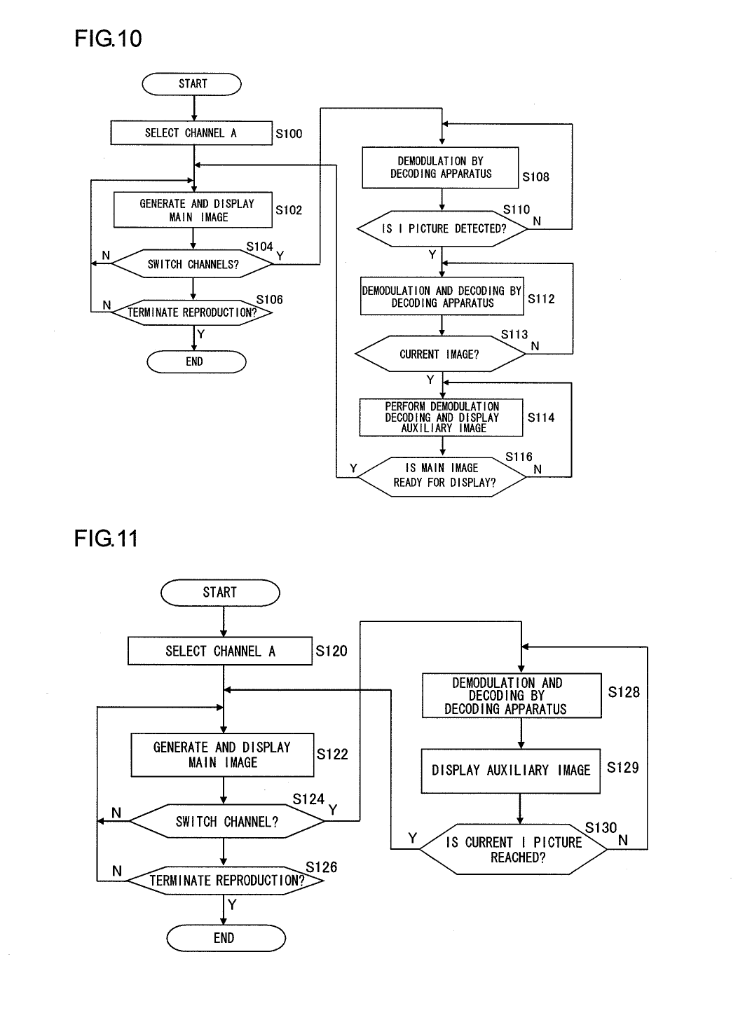

FIG. 10 is a flowchart showing the sequence of processing performed in the digital broadcast reproduction system 200 according to the second embodiment. As in FIG. 9, channel A is selected (S100), and the main image of channel A produced by demodulation and decoding processes performed by the television set 204 is displayed (S102). The processes are repeated unless an instruction for channel switching or termination of reproduction is given via the controller 72 (N in S104, N in S106). When a channel selection signal selecting another channel (e.g., channel B) is input (Y in S104), the process of switching to channel B as described with reference to FIG. 9 is performed in the television set 204 and the decoding apparatus 202. The second auxiliary demodulation unit 244 of the decoding apparatus 202 reads the digital data for channel B and demodulates the data accordingly (S108).

When an I picture is detected in the data stream thus demodulated, the auxiliary decoding unit 248 decodes the picture (Y in S110, S112). Meanwhile, the demodulation process of S112 is continuously performed for the data occurring after the channel switching. Since P pictures and B pictures are decoded by referring to I pictures (i.e., reference images), the decoding process is not performed until the first I picture is input (i.e., the decoding process is not started even when the data stream for channel B reaches the auxiliary decoding unit 248) (N in S110).

Meanwhile, the processes similar to those in S108-S112 are performed in the television set 204. However, the demodulation process in S108 performed in the television set 204 includes extraction of the signal of channel B and analog-to-digital conversion. Moreover, a relative long period of time is required until the input of an I picture, depending on the timing of channel switching, causing frequent branches of control to N in S110, with the result that the decoding process of S112 is delayed accordingly.

In the meantime, when the auxiliary image of channel B generated as a result of decoding by the decoding apparatus 202 represents the image for the current time (Y in S113), the display of that auxiliary image is started (S114). Meanwhile, the demodulation and decoding processes of S114 are continuously performed for the data occurring after the channel switching by the decoding apparatus. When the time that the main image can be displayed has come as defined previously (Y in S116), the main image of channel B demodulated and decoded by the television set 204 is displayed (S102). The timing may be defined such the maximum period of time, required until the first I picture of a newly selected channel reaches the main decoding unit 297 of the television set 204 and the decoding process is completed accordingly, elapses before the main image is displayed.

The auxiliary image may be switched to the main image dynamically by monitoring the arrival of an I picture at the main decoding unit 297 on a real time basis. FIG. 11 is a flowchart showing the sequence of processing performed when the switching is determined by the arrival of an I picture at the main decoding unit 297 of the television set 204.

In FIG. 11, as in FIG. 10, channel A is selected (S120), and the main image of channel A produced by demodulation and decoding processes performed by the television set 204 is displayed (S122). When a channel selection signal selecting channel B is input (Y in S124), the channel switching process is performed in the television set 204 and the decoding apparatus 202. The decoding apparatus 202 starts demodulating and decoding data for channel B (S128). When the auxiliary image for the current time is generated, that auxiliary image is displayed (S129). In FIG. 11, detection of an I picture in S110 of FIG. 10 and determination in S113 as to whether the auxiliary image represents the image for the current time are omitted from the illustration.

Meanwhile, the process similar to the process of S128 proceeds in the television set 204. When the first I picture for channel B reaches the main decoding unit 297 (Y in S130), the switching unit 299 switches the display so that the main image of channel B for the current time as decoded with reference to the I picture is displayed (S122). The arrival of the I picture may be communicated from the main decoding unit 297 to the switching unit 299. Alternatively, the arrival of the I picture for the current time at the auxiliary decoding unit 248 of the decoding apparatus 202 may be communicated from the decoding apparatus 202 to the switching unit 299. To ensure that the image is displayed properly, switching may take place when a predetermined period of time elapses since the arrival of the I picture. The aforementioned steps are repeated each time an instruction for channel switching is input until an instruction designating the termination of reproduction is input (N in S126). By performing switching dynamically, the operation of the decoding apparatus 202 is minimized so that power consumption is further reduced.

According to the embodiment described above, images demodulated and decoded by the television set are normally displayed. Only when the channel is switched, image data from the decoding apparatus is displayed. In this process, the decoding apparatus reads the digital data for the selected channel from the multichannel buffer, which temporarily stores digital data for a plurality of channels, and generates image data by demodulating and decoding the data thus read. As a result, the time lag between the input of the channel selection signal and the display of the image for that channel is reduced, as in the first embodiment.

Since parts of the demodulation and decoding processes performed by the decoding apparatus are activated only at the time of switching channels, the decoding apparatus, even if embodied by an apparatus having high computing power, can achieve high-speed response to channel switching while preventing power consumption from increasing. Since the computational cost of the decoding apparatus is low, the decoding apparatus, if embodied by a processor compatible with multitasking, will be less likely to cause a given task to interfere with the operation of another task executed in parallel. Therefore, a variety of system configurations can be implemented.

### Third Embodiment

The first and second embodiments implement a mechanism for instantaneously displaying the image of the channel selected by switching, by coordinating the television set and the decoding apparatus. In this case, an ordinary television set or a television set provided with the function of switching to the display of the image obtained from the decoding apparatus is tasked with displaying the image and the decoding apparatus is primarily tasked with improving the speed of response to channel switching. Accordingly, the response performance is further improved by providing a multichannel buffer in the decoding apparatus and installing a high-speed processor.

In the third embodiment, in addition to improving the response to channel switching by temporarily storing digital data for a plurality of channels, a control function is provided so that the decoding process is temporarily simplified in the event of channel switching. By adopting such a structure, image data can be generated by requiring smaller processing load so that the time required to generate image data is reduced. Simplification of the decoding process is achieved by, for example, reducing spatial resolution or temporal resolution. While the quality of resultant image data is lower, the time lag since the input of a channel selection signal and the display of the image for the selected channel is reduced so that the user stress caused by absence of display is reduced.

The structure of the third embodiment will prove more effective in, for example, a system where the function of a decoding apparatus is built in a television set not provided with a high-speed processor. Therefore, the following description is directed to a television set provided with the function of a decoding apparatus capable of simplifying the decoding process and the function of display images. However, the third embodiment may be implemented as a digital broadcast reproduction system where the function of controlling the decoding process is added to the decoding apparatus described in the first or second embodiment.

The basic method of processing is similar to that described with reference to FIG. 3 of the first embodiment. The following description primarily concerns the difference from the first embodiment shown in FIG. 3 or 6. Those constituting elements that are similar to those used in the first embodiment are denoted by the same reference numerals and the description of the elements is omitted.

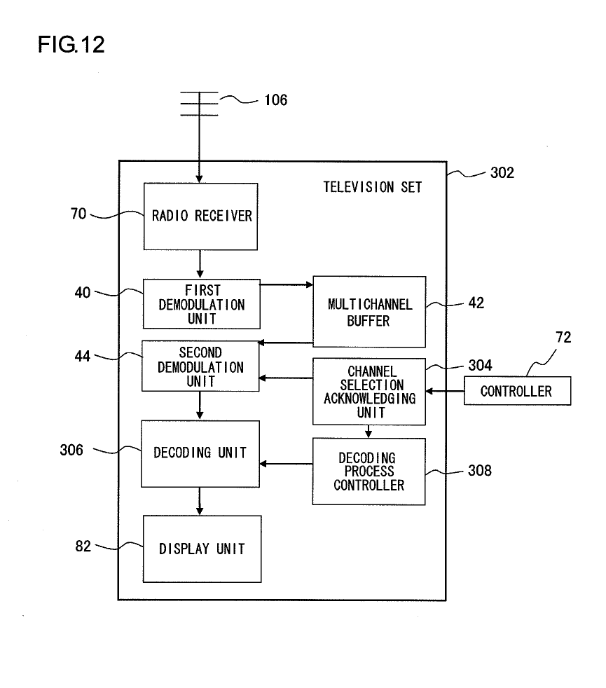

FIG. 12 shows the structure of the television set according to this embodiment. The television set 302 includes a radio receiver 70, a first demodulation unit 40, a multichannel buffer 42, a second demodulation unit 44, and a display unit 82. These constituting elements are similar to the corresponding constituting elements in FIG. 6 showing the first embodiment. The difference is that the elements of FIG. 12 are built in the television set 302.

The television set 302 also includes a channel selection acknowledging unit 304, a decoding unit 306, and a decoding process controller 308. The channel selection acknowledging unit 304 differs from the corresponding unit in the first embodiment in that the unit 304 not only changes the setting of the channel to be processed by the second demodulation unit 44 but also communicates the input of a channel selection signal to the decoding process controller 308. The decoding unit 306 differs from the corresponding unit in the first embodiment in that the unit 306 is provided with two modes, one mode being for generating normal image data, and the other mode being for performing a simplified process and generating image data with lower quality. Hereinafter, the former mode of decoding will be referred to as normal mode and the latter mode will be referred to as simplified mode. The decoding process controller 308 controls the switching of processing modes in the decoding unit 306.

When a channel selection signal is input from the controller 72 to the channel selection acknowledging unit 304 and the decoding process controller 308 is notified accordingly, the decoding process controller 308 rewrites processing mode identification information that is set in, for example, a register (not shown) of the decoding unit 306 so as to indicate a simplified mode. The decoding process controller 308 starts measuring elapsed time using a built-in timer (not shown). When the decoding unit 306 obtains a data stream for the channel selected by switching from the second demodulation unit 44, the decoding unit 306 refers to the register designating the simplified mode so as to start the decoding process in a simplified mode. This will instantly display images of reduced quality on the display unit 82. The decoding unit 306 continues the process by referring to the setting in the register each time it has completed processing one GOP.

The decoding process controller 308 refers to an internal timer. When a predetermined period of time has elapsed since the simplified mode is set in the register of the decoding unit 306, the controller 308 returns the setting in the register to the normal mode. This prompts the decoding unit 306 to start decoding the data stream normally, causing normal image data to be displayed on the display unit 82. The decoding process controller 308 may switch modes not only according to the elapsed time but also according to the number of frames processed. Either way, an appropriate period of time, or timing interval, required until a data stream sufficient for decoding in the normal mode has been buffered in the stream buffer of the decoding unit, is determined through experiments, simulation, or the like.

As mentioned before, images generated in the simplified mode may be regarded as versions of respective frames at reduced spatial or temporal resolution. More specifically, image data in the simplified mode may comprise only I pictures, or the resolution of the image may be increased progressively by using frames at low resolution initially. Alternatively, the image may be concurrently modified in a certain way while the decoding process is simplified. For example, the area subject to decoding is reduced by superimposing another image separately prepared.

According to this embodiment, when the channel is switched, the digital data for the selected channel is read from the multichannel buffer that temporarily stores digital data for a plurality of channels, so that image data is generated by demodulating and decoding the data thus read. Thus, the number of steps to be performed on the data for the selected channel is reduced. Similarly to the first embodiment, the time lag elapsed until the image of the channel is displayed is reduced.

In further accordance with this embodiment, the time required until the generation of image data is further reduced by simplifying the decoding process temporarily immediately after the decoding process in the selected channel is started. This enables the image for the selected channel to be displayed with less delay even in an apparatus with simplified processor architecture and not capable of high-speed operation. As a result, digital broadcast data is reproduced without stressing the user even at the time of channel switching, incurring only an inexpensive introduction cost and running cost.

Described above is an explanation based on exemplary embodiments. The embodiments are intended to be illustrative only and it will be obvious to those skilled in the art that various modifications to constituting elements and processes could be developed and that such modifications are also within the scope of the present invention.

The method used to reproduce digital television broadcast data is described with reference to the embodiments. The present invention is applicable not only to digital broadcast but also to any stream data covering respective channels simultaneously received and subject to a predetermined process before being output. For example, the invention improves the response of an output to the event of channel switching in, for example, digital radio, Internet television, a monitoring tool or a measurement tool for viewing or analyzing an output of images captured at a plurality of locations. Improvement is achieved by buffering partly processed data for a plurality of channels.

Further, the multichannel buffer for temporarily storing data for a plurality of channels may not be provided with a dedicated memory or storage area. In other words, memory capacity may be adaptively modified depending on the number of channels stored or the time required for demodulation or decoding. In this case, a buffer control function (not shown) operates to reserve an appropriate buffer area at a point of time that the function of the multichannel buffer is activated. In this case, a memory allocation method in an ordinary apparatus compatible with multitasking may be used. Meanwhile, a dedicated memory may be externally coupled as a multichannel buffer. Either way, the decoding apparatus shown in the first and second embodiments can be implemented as part of a multifunctional information processing apparatus that can be put to multiple uses. Therefore, expandable, hybrid systems can be built.

It is assumed that the decoding apparatus demodulates and decodes buffered digital data at the time of switching channels. Parts of the process may be performed by the television set. For example, the data stream generated by the demodulating process may be transmitted from the decoding apparatus to the television set so that the television set performs the decoding process and displays the image accordingly.

The embodiment may be modified such that buffered digital data or previous image data decoded by the decoding apparatus may be transmitted to the television set so that the television set performs the current decoding process by using the data thus transmitted. As mentioned before, the decoding apparatus is capable of generating image data that contains I-picture data occurring before the current time. By using such data, the decoding process can be performed at a comparatively early stage without causing the television set to have to wait for the arrival of I pictures of the selected channel obtained by subjecting broadcast waves to demodulation in the television set. For example, referring to the sequence of processing shown in FIG. 10, when the image obtained by decoding in the decoding apparatus represents the image for the current time (Y in S113), the image data that contains I-picture image data occurring immediately before is transmitted to the television set. The television set refers to the transmitted data so as to generate subsequent image data, i.e., image data after the current time and to display the image accordingly (S102). The variation above provides the same advantage as described in association with the foregoing embodiments.

### INDUSTRIAL APPLICABILITY

As described, the present invention is applicable to electronic devices such as computers, television sets, audio players, tuners connected to the devices, etc.

1. A decoding apparatus comprising:
a buffer operative to temporarily store digital data for a plurality of channels in units of predetermined sizes;
a channel selection acknowledging unit operative to acknowledge an input signal for selection of a channel; and
a decoding unit operative to read from the buffer the digital data for the channel selected by the input signal acknowledged by the channel selection acknowledging unit.

2. The decoding apparatus according to claim 1, further comprising:
a receiver operative to receive radio waves containing signals of a plurality of channels; and
a converter operative to sequentially convert the broadcast waves received by the receiver so as to generate the digital data for a plurality of channels.

3. The decoding apparatus according to claim 2, wherein the converter comprises a plurality of band pass filters each operative to extract a frequency component corresponding to a given channel from the broadcast waves received by the receiver, and a plurality of analog-to-digital converters each operative to subject the frequency component extracted by the band pass filter to analog-to-digital conversion so as to output the digital data, the number of band pass filters and analog-to-digital converters being determined by the number of channels received by the receiver.

4. The decoding apparatus according to claim 2, wherein
the converter comprises a band pass filter operative to extract frequency components corresponding to the plurality of channels from the broadcast waves received by the receiver, and an analog-to-digital converter operative to subject the frequency components extracted by the band pass filter to analog-to-digital conversion so as to output the digital data, and
the decoding unit comprises a digital filter operative to separate the digital data output by the analog-to-digital converter into data for respective channels.

5. The decoding apparatus according to claim 1, further comprising a decoding process controller operative to switch at least a part of the decoding process performed by the decoding unit to a simplified process until a predetermined time condition is met since the channel selection acknowledging unit acknowledges the input signal for selection of a channel.

6. A broadcast reproduction system comprising a decoding apparatus operative to decode broadcast data and a reproduction apparatus operative to decode the broadcast data and output the decoded data, wherein
the decoding apparatus comprises:
an auxiliary receiver operative to receive broadcast waves containing signals of a plurality of channels;
an auxiliary converter operative to convert the broadcast waves received by the auxiliary receiver and sequentially generate digital data for the plurality of channels;
a buffer operative to temporarily store digital data for a plurality of channels generated by auxiliary converter, in units of predetermined sizes;
a channel selection acknowledging unit operative to acknowledge an input signal for selection of a channel; and
an auxiliary decoding unit operative to read from the buffer the digital data for the channel selected by the input signal acknowledged by the channel selection acknowledging unit and to decode the read data so as to output auxiliary output data, wherein
the reproduction apparatus comprises:
a main receiver operative to receive the broadcast waves;
a switching unit operative to acknowledge the input signal for selection of a channel;
a main converter operative to extract, from the broadcast waves, the signal of the channel selected by the input signal acknowledged by the switching unit and to subject the extracted signal to conversion, thereby generating the digital data for the selected channel;
a main decoding unit operative to decode the digital data generated by the main converter and to generate main output data; and
an output unit operative to output the auxiliary output data generated by the auxiliary decoding unit or the main output data generated by the main decoding unit, wherein
the switching unit further controls the switching of outputs such that the auxiliary output data is obtained from the decoding apparatus and is output to the output unit until a predetermined timing condition is met since the input signal for selection of a channel is obtained.

7. The broadcast reproduction system according to claim 6, wherein
the auxiliary decoding unit halts the decoding process when a predetermined period of time has elapsed since the decoding process is started.

8. The broadcast reproduction system according to claim 6, wherein
the auxiliary decoding unit and the main decoding unit decode the digital data coded by inter-frame prediction, and
the switching unit controls the switching of outputs such that the main output data generated by the main decoding unit is output to the output unit after the arrival of the first I picture for the channel selected by the input signal for selection of a channel at the main decoding unit is detected.

9. The broadcast reproduction system according to claim 6, wherein
the switching unit controls the switching of outputs such that, in response to the acknowledgement of the input signal for selection of a channel, the auxiliary output data is output to the output unit when an image of the auxiliary output data output by the decoding apparatus represents an image currently occurring in the channel selected by the input signal.

10. A broadcast data reproduction apparatus comprising:
first and second processor units each operative to extract and decode a signal for a given channel from broadcast waves containing signals of a plurality of channels, in accordance with an input signal for selection of a channel; and
an output unit operative to output data decoded by the first processor unit or the second processor unit, wherein the speed of decoding process performed by the second processor unit is higher than that of the first processor unit, and
the output unit outputs the data decoded by the second processor unit for a predetermined period of time since the input signal is input and outputs the data decoded by the first processor unit at other periods.

11. The broadcast data reproduction apparatus according to claim 10, wherein
the second processor unit halts the decoding process when a predetermined period of time has elapsed since the input signal is input.

12. The broadcast data reproduction apparatus according to claim 10, wherein
the second processor unit sequentially store in a memory a part of data derived from simultaneously subjecting signals for a plurality of channels contained in the broadcast waves to a part of the decoding process, and the second processor unit completes the decoding process by reading data for the given channel from the digital data thus stored and by subjecting the data thus read to the remainder of the process.

13. A broadcast data reproduction apparatus comprising:
a first input unit operative to receive radio waves containing a plurality of channels;
a decoding unit operative to extract, from the radio waves received by the first input unit, and decode a signal for a channel selected by an input signal for selection of a channel and to generate main output data;
a second input unit operative to obtain, from an external apparatus, auxiliary output data derived from decoding the signal for the channel selected by the input signal; and
an output unit operative to output the auxiliary output data obtained by the second input unit for a predetermined period of time since the input signal is input and to output the main output data generated by the decoding unit at other periods.

14. An information processing method for performing first and second processes on a data stream being received and sequentially outputting the processed stream, comprising:
receiving a plurality of data streams;
performing the first process on the plurality of data streams so as to generate a plurality of items of intermediate data sequentially;
temporarily storing the plurality of items of intermediate data in a buffer in units of predetermined sizes; and
in response to an input signal selecting a data stream, reading an item of intermediate data corresponding to the selected data stream from the buffer, and performing the second process on the data thus read so as to generate output data.

15. A computer program product comprising:
a module that receives radio waves containing signals for a plurality of channels;
a module that converts the broadcast waves so as to generate digital data for the plurality of channels sequentially;
a module that temporarily stores the digital data for the plurality of channels in a buffer in units of predetermined sizes;
a module that acknowledges an input signal for selection of a channel; and
a module that reads the digital data for the channel selected by the input signal from the buffer and decodes the data thus read.

16. A recording medium having embodied thereon a computer program product comprising:
a module that receives radio waves containing signals for a plurality of channels;
a module that converts the broadcast waves so as to generate digital data for the plurality of channels sequentially;
a module that temporarily stores the digital data for the plurality of channels in a buffer in units of predetermined sizes;
a module that acknowledges an input signal for selection of a channel; and
a module that reads the digital data for the channel selected by the input signal from the buffer and decodes the data thus read.
